(19) United States
(12) Patent Application Publication
(10) Pub. No.: US 2009/0155576 A1
(43) Pub. Date: Jun. 18, 2009

(54) GLASS-LESS GLAZING LAMINATES

(75) Inventor: Jerrel C. Anderson, Vienna, WV (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/338,316

(22) Filed: Dec. 18, 2008

Related U.S. Application Data
(60) Provisional application No. 61/014,583, filed on Dec. 18, 2007.

(51) Int. Cl. B32B 27/36; B32B 27/40

(52) U.S. Cl. 428/335; 428/480; 428/483; 428/423.7; 428/334; 428/336; 428/339; 428/447

(57) ABSTRACT

A glass-less laminate comprising two hardcoated polyester films and a polymeric interlayer sheet bonded thereinbetween.

This application claims the benefit of U.S. Provisional Application No. 61/014,583, filed Dec. 18, 2007, the entire disclosure of which is incorporated herein by reference.

### FIELD OF THE INVENTION

The present invention relates to a glass-less laminated glazing.

### BACKGROUND OF THE INVENTION

A laminated glazing used in the art typically consists of a sandwich of two glass sheets or panels bonded together by a polymeric interlayer. In some cases, one of the glass sheets may be replaced by an optically clear rigid plastic sheet or a hardcoated plastic film. Such glass laminates are transparent, hard, and impact resistant. They can be used as windshields in automobiles and windows in buildings. However, the glass laminates are often heavy due to the use of glass. Moreover, when the laminate is impacted by hard objects, even at low speeds, the glass plates can be easily cracked.

Attempts have been made to develop glass-less laminated products for glazing in the past few years. For example, U.S. Pat. No. 7,147,923 discloses a transparent multi-layer sheet having a transparent flexible base layer formed of a substantially plasticizer-free polymer and two transparent flexible protective layers located on opposite sides of the base layer and each of the two protective layers are formed of a substantially plasticizer-free polyurethane. The glass-less laminate can be used as a window that is capable of being rolled up or folded. However, due to its flexibility, such glass-less laminates cannot be used to substitute glass laminates when stiffness is desired.

Thus there is a continuing need to develop glass-less laminated glazing products that are stiff, durable, transparent, safe, and light weight.

### SUMMARY OF THE INVENTION

The invention is directed to a glass-less laminate comprising two surface-treated and hardcoated polyester films and a polymeric interlayer sheet, wherein (a) the polymeric interlayer sheet is bonded between the two polyester films; (b) the outside surfaces of the polyester films are coated with an abrasion-resistant hardcoat; and (c) the inside surfaces of the polyester films are surface-treated to enhance their bonding to the polymeric interlayer sheet.

### DETAILED DESCRIPTION OF THE INVENTION

All publications, patent applications, patents, and other documents mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Although methods and materials similar or equivalent to those described herein can be used in the practice or testing of the present invention, suitable methods and materials are described herein.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

When the term “about” is used in describing a value or an end-point of a range, the disclosure should be understood to include the specific value or end-point referred to.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

Use of “a” or “an” are employed to describe elements and components of the invention. This is done merely for convenience and to give a general sense of the invention. This description should be read to include one or at least one and the singular also includes the plural unless it is obvious that it is meant otherwise.

In describing certain polymers it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

In describing and/or claiming this invention, the term “copolymer” is used to refer to polymers containing two or more monomers.

The invention provides a glass-less laminated glazing that is stiff, transparent, impact-resistant, abrasion-resistant, and light weight. Specifically, provided here is a laminated glazing comprising a polymeric interlayer sheet and bonded on each side thereof two surface-treated and hardcoated polyester films. The laminated glazing has a haze level up to about 30%, preferably up to about 20%, more preferably up to about 10%, and most preferably up to about 5%, and a Taber delta haze level up to about 10%, preferably up to about 5%, and more preferably up to about 3%. Moreover, the laminated glazing disclosed here can resist an impact energy up to about 230 ft-lbs.

### Surface-Treated and Hardcoated Polyester Films

Any polyester films may be used. Preferably, however, the polyester films are poly(ethylene terephthalate)(PET) films, or more preferably, bi-axially oriented poly(ethylene terephthalate) films.

The polyester films are surface-treated. By “surface-treated”, it is meant that inside surface of the polyester film, i.e., the surface that is adjacent to the interlayer sheet, has undergone a certain treatment to enhance its bonding to the interlayer sheet. Such surface treatments include energy treatments and the application of adhesives or primers. Suitable energy treatments are controlled flame treatment or plasma treatment. Suitable flame treating techniques are described in U.S. Pat. No. 2,632,921; U.S. Pat. No. 2,648,097; U.S. Pat. No. 2,683,984; and U.S. Pat. No. 2,704,382, and suitable plasma treating techniques are disclosed in U.S. Pat. No. 4,732,814. Suitable adhesives or primers include silanes, poly(alkyl amines), and acrylic based primers.

Exemplary silanes include vinyltriethoxysilane, vinyltrimethoxysilane, vinyltris(beta-methoxyethoxy)silane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldiethoxysilane, vinyl-triacetoxysilane, γ-mercaptopropyltrimethoxysilane, (3-aminopropyl)trimethoxysilane, (3-aminopropyl)triethoxysilane, N-β-(aminoethyl)-γ-aminopropyl-trimethoxysilane, N-(β-aminoethyl)-γ-aminopropylmethyldimethoxysilane, aminoethylaminopropyl silane triol homopolymer, vinylbenzylaminoethylaminopropyltrimethoxysilane, and mixtures thereof. Preferably, however, the silane used here is an amino-silane, such as, (3-aminopropyl)trimethoxysilane, (3-aminopropyl)triethoxysilane, N-β-(aminoethyl)-γ-aminopropyl-trimethoxysilane, N-(β-aminoethyl)-γ-aminopropylmethyldimethoxysilane, aminoethylaminopropyl silane triol homopolymer, vinylbenzylaminoethylaminopropyltrimethoxysilane, bis(trimethoxysilylpropyl)amine, or mixtures thereof. Commercial examples of amino-silanes include,
DOW CORNING® Z-6011 Silane (Dow Corning Corporation, Midland, Mich. (Dow Corning)), SILQUEST® A-1100 Silane and A-1102 Silane (GE Silicones, Friendly, W.Va. (GE Silicones)), which are believed to be (3-aminopropyl)triethoxysilane);
DOW CORNING® Z-6020 Silane (Dow Corning) and SILQUEST® A-1120 Silane, (GE Silicones), which are believed to be N-β-(aminoethyl)-γ-aminopropyl-trimethoxysilane);
SILQUEST® A-2120 Silane (GE Silicones), which is believed to be N-(β-aminoethyl)-γ-aminopropylmethyldimethoxysilane;
SILQUEST® A-1110 Silane (GE Silicones), which is believed to be γ-aminopropyltrimethoxysilane.
DOW CORNING® Z-6137 Silane (Dow Corning), which is believed to be aminoethylaminopropyl silane triol homopolymer;
DOW CORNING® Z-6040 Silane (Dow Corning) and SILQUEST® A-187 Silane (GE Silicones), which are believed to be γ-glycidoxypropyltrimethoxysilane;
DOW CORNING® Z-6130 Silane (Dow Corning), which is believed to be methacryloxypropyltrimethoxysilane;
DOW CORNING® Z-6132 Silane (Dow Corning), which is believed to be vinylbenzylaminoethylaminopropyltrimethoxysilane;
DOW CORNING® Z-6142 Silane (Dow Corning), which is believed to be γ-glycidoxypropylmethyldiethoxysilane;
DOW CORNING® Z-6075 Silane (Dow Corning), which is believed to be vinyltriacetoxysilane;
DOW CORNING® Z-6172 Silane (Dow Corning) and SILQUEST® A-172 Silane (GE Silicones), which are believed to be vinyl tris(methoxyethoxy)silane;
DOW CORNING® Z-6300 Silane (Dow Corning) and SILQUEST® A-171 Silane (GE Silicones), which are believed to be vinyltrimethoxysilane;
DOW CORNING® Z 6518 Silane (Dow Corning) and SILQUEST® A-151 Silane (GE Silicones), which are believed to be vinyltriethoxysilane; and
SILQUEST® A-1170 Silane (GE Silicones), which is believed to be bis(trimethoxysilylpropyl)amine.

The poly(alkyl amines) used here include those derived from α-olefin comonomers having 2-10 carbon atoms, such as, ethylene, propylene, 1-butene, 1-pentene, 1-hexene, 1-heptene, 3-methyl-1-butene, 4-methyl-1-pentene, and mixtures thereof. More particularly, the poly(alkyl amine) may be selected from poly(allyl amines) and poly(vinyl amines) (e.g., linear poly(vinyl amine) available from BASF Corporation, Florham Park, N.J., under the tradename LUPAMIN® 9095). Preferably, however, the poly(alkyl amine) is a poly(allyl amine), or linear poly(allyl amine). The poly(allyl amine) primer or coating, and its application to the polyester film surface(s) are described in U.S. Pat. No. 5,411,845; U.S. Pat. No. 5,770,312; U.S. Pat. No. 5,690,994; and U.S. Pat. No. 5,698,329.

Acrylic based primers, such as, hydroxyacrylic hydrosol primers, are disclosed in U.S. Pat. No. 5,415,942.

The adhesives or primers may be applied through melt processes or through solution, emulsion, dispersion, and the like, coating processes. One of ordinary skill in the art will be able to identify appropriate process parameters based on the composition and process used for the coating formation. For example, the adhesive or primer composition can be cast, sprayed, air knifed, brushed, rolled, poured or printed or the like onto the film layer surface. Generally the adhesive or primer is diluted into a liquid medium prior to application to provide uniform coverage over the film surface. The liquid media may function as a solvent for the adhesive or primer to form solutions or may function as a non-solvent for the adhesive or primer to form dispersions or emulsions. Coatings may also be applied by spraying.

Preferably, the inside surface of the polyester film is primed with a poly(alkyl amine), or more preferably a poly(allyl amine) primer.

The thickness of the primer or adhesive coating can be up to about 1,000 nanometers (nm), or about 0.2 to about 1,000 nm, or about 5 to about 500 nm, or about 10 to about 200 nm.

By “hardcoated”, it is meant that the outside surface of the polyester film, i.e., the surface that is facing away from the interlayer sheet, is coated with a clear anti-scratch and anti-abrasion hardcoat. Suitable hardcoat may be formed of polysiloxanes or cross-linked (thermosetting) polyurethanes, such as those disclosed in U.S. Pat. No. 5,567,529 and U.S. Pat. No. 5,763,089. Other suitable hardcoats are the oligomeric-based coatings disclosed in U.S. Pat. No. 7,294,401, which compositions are prepared by the reaction of (A) hydroxyl-containing oligomer with isocyanate-containing oligomer or (B) anhydride-containing oligomer with epoxide-containing compound.

In practice, prior to applying the hardcoat, the outside surface of the polyester film also needs to undergo certain energy treatments or be coated with certain adhesives or primers to enhance the bonding between the polyester film and the hardcoat. The energy treatments and the adhesives or primers disclosed in the above paragraphs can be used herein as well. Preferably, however, acrylic based primers (e.g., hydroxyacrylic hydrosol) are used to enhance the bonding between the outside surface of the polyester film and the hardcoat. In this application, a “hardcoated polyester film” or a “polyester film coated with an abrasion-resistant hardcoat” refers to a polyester film having one surface coated with an anti-scratch and anti-abrasion hardcoat and that a suitable adhesive layer is applied in-between the polyester film and the hardcoat, or that the polyester film has undergone an energy treatment prior to the application of the hardcoat.

In this invention, the hardcoat generally has a thickness of up to about 100 μm. Specifically, for those hardcoats comprising or produced from polysiloxanes, the thickness of the hardcoat may range from about 1 to about 4.5 μm, preferably about 1.5 to about 3.0 μm, and more preferably about 2.0 to about 2.5 μm, while for those hardcoats comprising or produced from polyurethanes, the thickness of the hardcoat may range from about 5 to about 100 μm, and preferably about 5 to about 50 μm.

Furthermore, a solar control layer formed of solar control materials (e.g., infrared-absorbing or infrared-reflecting materials) may be further applied to one or both surfaces of the polyester film underneath the primer or adhesive coatings. Exemplary infrared-absorbing materials include metal oxide nanoparticles (e.g., antimony tin oxide (ATO) and indium tin oxide (ITO)) and metal boride nanoparticles (e.g., lanthanum hexaboride (LaB6)). A simple semi-transparent metal layer or a series of metal/dielectric layers may be applied to the polyester film surface as an infrared energy reflective layer. Commercial examples of polyester films coated with metal/dielectric stacks are available from Southwall Technologies, Inc. (Palo Alto, Calif.) under the trade names of XIR™ 70 and XIR™ 75.

The polyester films used here preferably have a thickness of about 1 to about 14 mils (25-356 μm), preferably about 2 to about 10 mils (51-254 μm), and more preferably about 2 to about 7 mils (51-178 μm).

### Interlayer Sheets

The interlayer sheet used here may be derived from (or made of) any polymeric material(s). Suitable polymeric material(s) include, but are not limited to, poly(vinyl acetals), poly(vinyl chlorides), polyurethanes, poly(ethylene-co-vinyl acetates) (e.g., ethylene vinyl acetate), acid copolymers of α-olefins and α,β-unsaturated carboxylic acids having from 3 to 8 carbons, and ionomers derived from partially or fully neutralized acid copolymers of α-olefins and α,β-unsaturated carboxylic acids having from 3 to 8 carbons, or a combination of two or more thereof.

Poly(vinyl acetal) is resulted from the condensation of polyvinyl alcohol with an aldehyde, such as acetaldehyde, formaldehyde, or butyraldehyde. When used as the interlayer material, a suitable amount of one or more plasticizers is comprised in the poly(vinyl acetal) composition. The poly(vinyl acetal) compositions used herein also include acoustic grade compositions. By “acoustic” it is meant that the poly(vinyl acetal) composition has a glass transition temperature (Tg) of 23° C. or less, or about 20° C. to about 23° C. The Tg of the poly(vinyl acetal) composition may be determined as described in US 20060210776, by rheometric dynamic shear mode analysis. Such acoustic poly(vinyl acetal) compositions are disclosed in U.S. patent application Ser. No. 11/801,795, filed on May 11, 2007.

Preferably the polymeric interlayer comprises poly(vinyl acetal) or ionomer. A preferred poly(vinyl acetal) is poly(vinyl butyral).

The ionomers used herein are derived from parent acid copolymers of α-olefins and α,β-ethylenically unsaturated carboxylic acid having 3 to 8 carbons. Preferably, about 15 to about 30 wt %, more preferably about 18 to about 25 wt %, and most preferably about 18 to about 23 wt %, of the repeat units of the parent acid copolymers are derived from α,β-ethylenically unsaturated carboxylic acids. Preferably, the parent acid copolymers comprise repeat units derived from α-olefins having 2-10 carbon atoms, or α-olefins selected from ethylene, propylene, 1-butene, 1-pentene, 1-hexene, 1-heptene, 3 methyl-1-butene, 4-methyl-1-pentene, and mixtures thereof. More preferably, the α-olefin used here is ethylene and the α,β-ethylenically unsaturated carboxylic acids used here is selected from acrylic acid, methacrylic acid, itaconic acid, maleic acid, maleic anhydride, fumaric acid, monomethyl maleic acid, and mixtures thereof.

The parent acid copolymers used herein may be polymerized as disclosed in U.S. Pat. No. 3,404,134; U.S. Pat. No. 5,028,674; U.S. Pat. No. 6,500,888; and U.S. Pat. No. 6,518,365.

To produce the ionomers used here, the parent acid copolymers are neutralized less than 100%, preferably about 5 to about 90%, more preferably about 10 to about 50%, and most preferably about 20 to about 40%, based on the total number of equivalents of carboxylic acid moieties. Metallic ions that are useful in neutralizing the parent acid copolymers may be monovalent, divalent, trivalent, multivalent, or mixtures therefrom. Useful monovalent metallic ions include, but are not limited to, ions of sodium, potassium, lithium, silver, mercury, copper and the like and mixtures thereof. Useful divalent metallic ions include, but are not limited to, ions of beryllium, magnesium, calcium, strontium, barium, copper, cadmium, mercury, tin, lead, iron, cobalt, nickel, zinc and the like and mixtures therefrom. Useful trivalent metallic ions include, but are not limited to, ions of aluminum, scandium, iron, yttrium and the like and mixtures therefrom. Useful multivalent metallic ions include, but are not limited to, ions of titanium, zirconium, hafnium, vanadium, tantalum, tungsten, chromium, cerium, iron and the like and mixtures therefrom. The parent acid copolymers are preferably neutralized with lithium, magnesium, sodium, potassium, zinc, or mixtures thereof, or more preferably neutralized with zinc, sodium, or mixtures thereof, or most preferably neutralized with sodium. It is noted that when the metallic ion is multivalent, complexing agents, such as stearate, oleate, salicylate, and phenolate radicals may be included, as disclosed within U.S. Pat. No. 3,404,134. The parent acid copolymers may be neutralized as disclosed in U.S. Pat. No. 3,404,134.

It is understood that the polymeric compositions used here in the interlayer sheet may further comprise one or more suitable additives. The additives may include fillers, plasticizers, processing aids, flow enhancing additives, lubricants, pigments, dyes, colorants, flame retardants, impact modifiers, nucleating agents, lubricants, antiblocking agents such as silica, slip agents, thermal stabilizers, UV absorbers, UV stabilizers, hindered amine light stablizers, dispersants, surfactants, chelating agents, coupling agents, adhesives, primers and the like.

The polymeric compositions may contain an effective amount of a thermal stabilizer. Any thermal stabilizer may find utility herein. Preferable general classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. This should not be considered limiting. Basically any thermal stabilizer can be used. When used, the compositions preferably incorporate about 0.05 to about 10 wt %, more preferably about 0.05 to about 5 wt %, and most preferably about 0.05 to about 1 wt % of thermal stabilizers, based on the total weight of the composition.

The polymeric compositions may contain an effective amount of UV absorber(s). Preferable general classes of UV absorbers include benzotriazoles, hydroxybenzophenones, hydroxyphenyl triazines, esters of substituted and unsubstituted benzoic acids, and the like and mixtures thereof. This should not be considered limiting. Basically any UV absorber may be used. The compositions may contain about 0.05 to about 10 wt %, preferably about 0.05 to about 5 wt %, and more preferably about 0.05 to about 1 wt % of UV absorbers, based on the total weight of the composition.

The polymeric compositions may contain an effective amount of hindered amine light stabilizers (HALS). Hindered amine light stabilizers include secondary, tertiary, acetylated, N-hydrocarbyloxy substituted, hydroxy substituted N-hydrocarbyloxy substituted, or other substituted cyclic amines which further contain steric hindrance, generally derived from aliphatic substitution on the carbon atoms adjacent to the amine function. This should not be considered limiting. Basically any hindered amine light stabilizer may be used. When used, the compositions may contain about 0.05 to about 10 wt %, preferably about 0.05 to about 5 wt %, and more preferably about 0.05 to about 1 wt % of hindered amine light stabilizers, based on the total weight of the composition.

The interlayer sheet used here may be a single-layer or multi-layer polymeric sheet. The individual sub-layers of the interlayer sheet may independently have any thickness. The interlayer sheet, as a whole, preferably has a total thickness of at least about 5 mils (0.1 mm), more preferably at least about 30 mils (0.8 mm), and even more preferably at least about 45 mils (1.1 mm), and can be up to about 200 mils (5.1 mm), preferably up to about 100 mils (2.5 mm), and more preferably up to about 90 mils (2.3 mm).

### Process

The glass-less laminated glazing disclosed herein may be produced through any suitable process. In a preferred process, the glazing product is produced by a lamination process, such as the processes described below.

In a conventional autoclave process, the component layers of the laminated glazing are stacked in the desired order and sandwiched between two cover plates to form a pre-lamination assembly. The cover plates used here are typically made of glass, smooth metal, or other stiff and smooth surfaced material having a higher melt point than the polymeric material used in the interlayer sheet. Optionally, the pre-lamination assembly may further comprise two release liners placed between each of the two hardcoated polyester films and the rigid cover plate adjacent to it to facilitate de-airing during the lamination process. The release liners used here may be formed of any suitable polymeric material, such as Teflon® films (E.I. du Pont de Nemours and Company (DuPont)) or polyolefin films. The assembly is then placed into a bag capable of sustaining a vacuum (“a vacuum bag”), the air is drawn out of the bag by a vacuum line or other means, the bag is sealed while the vacuum is maintained (e.g., about 26 to about 30 in Hg (660-762 mm Hg), or preferably about 27 to about 28 in Hg (689-711 mm Hg)), and the sealed bag is placed in an autoclave at a pressure of about 150 to about 250 psi (about 11.3-18.8 bar), a temperature of about 130° C. to about 180° C., preferably about 120° C. to about 160° C., more preferably about 135° C. to about 160° C., and most preferably about 145° C. to about 155° C., for about 10 to about 50 minutes, preferably about 20 to about 45 minutes, more preferably about 20 to about 40 minutes, and most preferably about 25 to about 35 minutes. A vacuum ring may be substituted for the vacuum bag. One type of suitable vacuum bags is disclosed within U.S. Pat. No. 3,311,517.

Alternatively, the pre-lamination assembly may be heated in an oven at about 80° C. to about 120° C., preferably about 90° C. to about 100° C., for about 20 to about 40 minutes, and thereafter, the heated assembly is passed through a set of nip rolls so that the air in the void spaces between the individual layers may be squeezed out, and the edge of the assembly sealed. The assembly at this stage is referred to as a pre-press.

The pre-press may then be placed in an air autoclave where the temperature is raised to about 120° C. to about 160° C., or preferably about 135° C. to about 160° C., at a pressure of about 100 to about 300 psi (about 6.9-20.7 bar), or preferably about 200 psi (13.8 bar). These conditions are maintained for about 15 to about 60 minutes, or preferably about 20 to about 50 minutes, and after which, the air is cooled while no more air is added to the autoclave. After about 20 to about 40 minutes of cooling, the excess air pressure is vented, the laminated products are removed from the autoclave and the cover plates and the release liners are removed.

The laminates can also be produced through non-autoclave processes. Such non-autoclave processes are disclosed, for example, within U.S. Pat. No. 3,234,062; U.S. Pat. No. 3,852,136; U.S. Pat. No. 4,341,576; U.S. Pat. No. 4,385,951; U.S. Pat. No. 4,398,979; U.S. Pat. No. 5,536,347; U.S. Pat. No. 5,853,516; U.S. Pat. No. 6,342,116; U.S. Pat. No. 5,415,909; US 2004/0182493; EP 1 235 683 B1; WO 91/01880; and WO 03/057478 A1. Generally, the non-autoclave processes include heating the pre-lamination assembly and the application of vacuum, pressure or both. For example, the assembly may be successively passed through heating ovens and nip rolls.

This should not be considered limiting. Basically any lamination process may be used.

The laminate can also be produced by extrusion coating a polymeric interlayer over a first layer of hardcoated and surface treated polyester film followed by applying a second layer of hardcoated and surface treated polyester film over the polymeric interlayer. Preferably, the second polyester film layer is applied in-line while the polymeric interlayer is still molten, preferably with the application of pressure to force the second polyester film layer onto the polymeric interlayer such as with nip rolls.

Alternatively, a bilayer structure of the polymeric interlayer and the hardcoated and surface treated polyester film, preferably produced through an extrusion coating or a lamination process, can be used to produce the laminate. In this embodiment, a hardcoated and surface treated polyester is applied to the bilayer structure through a lamination process, such as described above.

### EXAMPLES

The following Examples and Comparative Examples are intended to be illustrative of the present invention, and are not intended in any way to limit the scope of the present invention.

### Lamination Process

An autoclave lamination process is used to prepare the laminates described in the following examples. Specifically, during the lamination process, the component layers of the laminate were assembled in order and placed between two glass cover plates. Such a pre-lamination assembly was then placed in a vacuum bag. After the air was removed, the vacuum bag was sealed under vacuum and autoclaved at a temperature of 135° C. and pressure of 17 atm for 30 minutes. The assembly was cooled while in the autoclave and then removed. A final laminate was then obtained after the removal of the glass cover plates.

### Examples 1-6

Examples 1-6 were a series of glass-less laminated glazing prepared by the lamination process described above. Their optical and abrasion properties were determined and tabulated in Table 1.

TABLE 1

| | Thickness | Thickness | | | | | |
|---|---|---|---|---|---|---|---|
| | of | of | | | | Taber | |
| | Interlayer | Polyester | | | | Delta | |
| | Sheet | Film | | Haze | Tvis | Haze | b* |
| Sample # | (mils) | (mils) | Laminate Construction | (%) | (%) | (%) | Color |
| E1 | 90 | 6.5 | (HC)PET(P)/PVB/(P)PET(HC) | 2.7 | 91.7 | 2.2 | 4.03 |
| E2 | 180 | 6.5 | (HC)PET(P)/PVB/(P)PET(HC) | 3 | 91.1 | 1.8 | 6.12 |
| E3 | 90 | 6.5 | (HC)PET(P)/ION/(P)PET(HC) | 4.3 | 90.6 | 2.2 | 2.18 |
| E4 | 180 | 6.5 | (HC)PET(P)/ION/(P)PET(HC) | 3.8 | 89.6 | 1.4 | 3.00 |
| E5 | 90 | 7 | (HC)PET/PVB/PET(HC) | 0.9 | 92.9 | | |
| E6 | 90 | 7 | (HC)PET/ION/PET(HC) | 1.5 | 92.8 | | |

“(HC)PET(P)” and “(P)PET(HC)” are MELINEX ™ 535 polyester films (E. I. du Pont de Nemours and Company, Wilmington, DE (DuPont)) which have both surfaces in-line primed with poly(allyl amine) and the outside surface further coated with a polysiloxane abrasion-resistant hardcoat (U.S. Pat. No. 5,069,942).
“(HC)PET” and “PET(HC)” are CRONAR ™ polyester films (DuPont) which have both surfaces flame treated and the outside surface further coated with a polysiloxane abrasion-resistant hardcoat (U.S. Pat. No. 5,069,942).
“PVB” is a BUTACITE ™ poly(vinyl butyral) sheet (DuPont).
“ION” is a SENTRYGLAS ™ Plus ionomer sheet (DuPont).
Haze and Tvis were measured using HAZE GARD PLUS from BYK Gardner, Columbia, MD, in accordance with ASTM D1003-61.
Taber delta haze (abrasion resistance test) was measured using a Taber Abraser in accordance to ANSI Z26.1, test No. 34. Specifically, 4 × 4 in (10 × 10 cm) laminates were rotated 100 cycles under CS-10F abrader wheels using 500 g load, and haze was measured in accordance to ASTM D1003.61.
b* Color was measured by transmitted light using a ColorFlex ® Spectrocolormeter (HunterLab, Reston, VA) and calculated using CIE Equation and ASTM E308.

### Examples CE1-2 and E7-8

A series of glass laminates (CE1-2) and glass-less laminates (E7-8) were prepared and tested for their impact performance. Specifically, the test involved a 14-ft (4-m) pendulum with an impacting head on the bottom, where the impacting head had a 3-in (76-mm) diameter still hemisphere, and could have additional weights added thereon. The 12×12 in (305×305 mm) sample laminates were held vertically in a steel frame, which were fitted with a rubber gasket and held in by bolts. During the test, the impacting head was raised on the arc of the pendulum to a certain height and then released. The energy of the impact was recorded as the “height×weight” (ft-lbs) and the indent depth (if no penetration occurred) and glass loss (by weight), as a result of the impact, were measured. The results, which are tabulated in Table 2, demonstrate that the glass-less laminates of Examples E7-8 possess comparative impact-resistance compared to the glass laminates of Comparative Examples CE1-2. Moreover, the glass-less laminates of E7-8 are much lighter than the glass laminates of CE1-2.

TABLE 2

| | | | Pendulum | | | Laminate Weight | | | | |
|---|---|---|---|---|---|---|---|---|---|---|
| | | Interlayer | Drop | Impact | Indent | (grams) | | Result | | |
| Sample | Laminate | Thickness | Height | Energy | Depth | Before | After | | | Broken |
| No. | Construction | (mils) | (inches) | (ft-lbs) | (mm) | Impact | Impact | Penetration | Tear | Glass |
| CE1 | GLASS/PVB/ | 90 | 12* | 70 | 38 | 1,252 | 1,243 | No | No | Yes |
| | GLASS | | | | | | | | | |
| | | | 24* | 140 | 44 | 1,261 | 1,252 | No | 0.75 in | Yes |
| | | | 34* | 199 | n/a | 1,243 | 1,225 | Fully | n/a | Yes |
| | | | | | | | | penetrated | | |
| E7 | PET(P)/PVB/ | 90 | 35** | 147 | 35 | 272 | 272 | No | No | n/a |
| | (P)PET | | | | | | | | | |
| | | | 45** | 189 | 44 | 270 | 270 | No | No | n/a |
| | | | 55** | 231 | 19*** | 264 | 264 | No | No | n/a |
| CE2 | GLASS/ION/ | 90 | 34* | 199 | 27 | 1,243 | 1,160 | No | 4.5 in | Yes |
| | GLASS | | | | | | | | | |
| | | | 42* | 245 | 32 | 1,252 | 1,188 | No | 3.5 in | Yes |
| | | | 48* | 280 | n/a | 1,243 | 1,089 | Fully | n/a | Yes |
| | | | | | | | | penetrated | | |
| E8 | PET(P)/ION/ | 90 | 35** | 147 | 16 | 263 | 263 | No | No | n/a |
| | (P)PET | | | | | | | | | |
| | | | 45** | 189 | 17 | 258 | 258 | No | No | n/a |
| | | | 55** | 231 | 24 | 260 | 260 | No | No | n/a |

“GLASS” is 90 mil (2.3 mm) thick annealed float glass;
“PET(P)” and “(P)PET” are 6.5 poly(ethylene terephthalate) films having primed with poly(allyl amine) on the inside surfaces and hardcoated on the outside surfaces;
“PVB” is a poly(vinyl butyral) sheet;
“ION” is an ionomer sheet;
“n/a”: not applicable;
Pendulum weight = 70.12 lbs;
**Pendulum weight = 50.48 lbs;
***The laminate was partially pulled out of the frame on the impact.

What is claimed is:

1. A glass-less laminate comprising two surface-treated and hardcoated polyester films and a polymeric interlayer sheet, wherein (a) the polymeric interlayer sheet is bonded between the two polyester films; (b) the outside surfaces of the polyester films are coated with an abrasion-resistant hardcoat; and (c) the inside surfaces of the polyester films are surface-treated to enhance their bonding to the polymeric interlayer sheet.

2. The glass-less laminate of claim 1, wherein the polymeric interlayer sheet comprises a polymeric material selected from poly(vinyl acetals), poly(vinyl chlorides), polyurethanes, poly(ethylene-co-vinyl acetates), acid copolymers of α-olefins and α,β-unsaturated carboxylic acids having from 3 to 8 carbons, and ionomers derived from partially or fully neutralized acid copolymers of α-olefins and α,β-unsaturated carboxylic acids having from 3 to 8 carbons.

3. The glass-less laminate of claim 1, wherein the polymeric interlayer sheet is an ionomeric interlayer sheet wherein the ionomer is derived from a partially or fully neutralized acid copolymer of an α-olefin and a α,β-unsaturated carboxylic acid having from 3 to 8 carbons, and wherein the acid copolymer is about 10% to 60% neutralized with one or more metallic ions.

4. The glass-less laminate of claim 1, wherein the polymeric interlayer sheet is a poly(vinyl acetal) interlayer sheet.

5. The glass-less laminate of claim 1, wherein the polymeric interlayer sheet is a poly(vinyl butyral) interlayer sheet.

6. The glass-less laminate of claim 1, which has a haze level up to about 10%.

7. The glass-less laminate of claim 1, which has a Taber delta haze level up to about 10%.

8. The glass-less laminate of claim 1, which has a haze level up to about 5% and a Taber delta haze level up to about 5%.

9. The glass-less laminate of claim 1, wherein the polyester films are poly(ethylene terephthalate) films.

10. The glass-less laminate of claim 1, wherein the polyester films are bi-axially oriented poly(ethylene terephthalate) films.

11. The glass-less laminate of claim 1, wherein the thickness of the polyester films is about 1 to about 14 mils.

12. The glass-less laminate of claim 10, wherein the thickness of the polyester films is about 2 to about 7 mils.

13. The glass-less laminate of claim 1, wherein the abrasion-resistant hardcoat is formed of a material selected from the group consisting of polysiloxanes, cross-linked polyurethanes, and composition prepared by the reaction of (A) hydroxyl-containing oligomer with isocyanate-containing oligomer or (B) anhydride-containing oligomer with epoxide-containing compound.

14. The glass-less laminate of claim 1, wherein the surface-treatment to the inside surfaces of the polyester films is (i) an energy treatment or (ii) the application of an adhesive material selected from silanes, poly(alkyl amines), and acrylic based primers.

15. The glass-less laminate of claim 1, wherein the inside surfaces of the polyester films are primed with poly(alkyl amine).

16. The glass-less laminate of claim 15, wherein the poly(alkyl amine) is poly(allyl amine).

17. The glass-less laminate of claim 1, wherein the polymeric interlayer sheet has a thickness of about 30 to about 200 mils.

18. The glass-less laminate of claim 2, wherein the polymeric interlayer sheet has a thickness of about 45 to about 100 mils.

19. The glass-less laminate of claim 1, wherein:
(a) the polymeric interlayer sheet has a thickness of about 30 to about 200 mils and is selected from the group consisting of: (i) ionomeric interlayer sheets wherein the ionomer is derived from partially or fully neutralized acid copolymer of α-olefin and an α,β-unsaturated carboxylic acid having from 3 to 8 carbons, and wherein the acid copolymer is about 10% to about 60% neutralized with one or more metallic ions, and (ii) poly(vinyl butyral) interlayer sheets;
(b) the polyester films are poly(ethylene terephthalate) films having a thickness of about 1 to about 14 mils;
(c) the abrasion-resistant hardcoat is formed of a material selected from the group consisting of (i) polysiloxanes, (ii) cross-linked polyurethanes, and (iii) compositions prepared by the reaction of (A) hydroxyl-containing oligomer with isocyanate-containing oligomer or (B) anhydride-containing oligomer with epoxide-containing compound; and
(d) the inside surfaces of the polyester films is surface-treated with (i) an energy treatment or (ii) the application of an adhesive material selected from silanes, poly(alkyl amines), and acrylic based primers.

20. The glass-less laminate of claim 19, wherein
(a) the glass-less laminate has a haze level up to about 5% and a Taber delta haze level up to about 5%;
(b) the polymeric interlayer sheet has a thickness of about 45 to about 100 mils;
(c) the polyester films are bi-axially oriented poly(ethylene terephthalate) films having a thickness of 2 to about 7 mils; and
(d) the inside surfaces of the polyester films are primed with a poly(allyl amine).

21. A glass-less laminate consisting essentially of two surface-treated and hardcoated polyester films and a polymeric interlayer sheet, wherein (a) the polymeric interlayer sheet is bonded between the two polyester films; (b) the outside surfaces of the polyester films are coated with an abrasion-resistant hardcoat; and (c) the inside surfaces of the polyester films are surface-treated to enhance their bonding to the polymeric interlayer sheet.

22. The glass-less laminate of claim 21, wherein:
(a) the polymeric interlayer sheet has a thickness of about 30 to about 200 mils and is selected from the group consisting of: (i) ionomeric interlayer sheets wherein the ionomer is derived from partially or fully neutralized acid copolymer of α-olefin and an α,β-unsaturated carboxylic acid having from 3 to 8 carbons, and wherein the acid copolymer is about 10% and about 60% neutralized with one or more metallic ions, or (b) poly(vinyl butyral) interlayer sheets;
(b) the polyester films are poly(ethylene terephthalate) films having a thickness of about 1 to about 14 mils;
(c) the abrasion-resistant hardcoat is formed of a material selected from the group consisting of (i) polysiloxanes, (ii) cross-linked polyurethanes, and (iii) compositions prepared by the reaction of (A) hydroxyl-containing oligomer with isocyanate-containing oligomer or (B) anhydride-containing oligomer with epoxide-containing compound; and
(d) the inside surfaces of the polyester films is surface-treated with (i) an energy treatment or (ii) the application of an adhesive material selected from silanes, poly(alkyl amines), and acrylic based primers.

23. The glass-less laminate of claim 22, wherein
(a) the glass-less laminate has a haze level up to about 5% and a Taber delta haze level up to about 5%;
(b) the polymeric interlayer sheet has a thickness of about 45 to about 100 mils;
(c) the polyester films are bi-axially oriented poly(ethylene terephthalate) films having a thickness of 2 to about 7 mils; and
(d) the inside surfaces of the polyester films are primed with poly(allyl amine).
